(19) United States
(12) Patent Application Publication
(10) Pub. No.: US 2002/0034384 A1
(43) Pub. Date: Mar. 21, 2002

(54) Location sensing camera

(76) Inventor: Peter G. Mikhail, San Francisco, CA (US)

Correspondence Address: PETER MIKHAIL, 1841 CARPENTER DR, TROY, MI, 48098, US

(21) Appl. No.: 09/954,801

(22) Filed: Sep. 18, 2001

Related U.S. Application Data
(60) Provisional application No. 60/233,631, filed on Sep. 18, 2000.

(51) Int. Cl. G03B 17/24

(52) U.S. Cl. 396/310

(57) ABSTRACT

A camera system that determines the location of the image taken and records the location coordinates and/or name together with the date, time and/or other information selected by the user.

### CROSS-REFERENCE TO RELATED APPLICATION

This application claims priority from U.S. Provisional Patent Application No. 60/233,631 filed Sep. 18, 2000.

### BACKGROUND OF THE INVENTION

Cameras have for some time been able to record various information about when a picture was taken and under what circumstances. Such information is very useful in organizing and analyzing photos or videos after they have been taken. Normally, the time and date can be stored on the recording media, whether the media is an optical film, integrated circuit memory, or magnetic video. In addition, the ability to record exposure settings such as the aperture, shutter speed, and exposure compensation is a valuable asset for the photographer.

Heretofore data imprinting systems are well known in the art, and a databack (data recording system) which is an accessory system of a camera and which records data including date information and copyright information was described in U.S. Pat. No. 5,526,079, which is hereby incorporated by reference, also published as Japanese Patent Application 1991-318631. This data recording system uses an array of light emitting diodes (LEDs) to optically record and/or display date information, time information and/or information including the photographer's name inside or outside of the photographic screen on the film. The date and/or time of the photograph are automatically recorded by this system, making it beneficial when arranging photographs later and with commemorative photographs. This data recording system is also valuable in asserting copyrights because it can automatically record the necessary copyright information on the surface of the film. The data to be recorded is displayed by a liquid crystal display element (LCD) so that the information can be verified by the photographer before it is recorded. Another data imprinting system well known in the art is described in U.S. Pat. No. 5,903,785 which is hereby incorporated by reference, and illustrates how a date recordable camera incorporates a date recording device having a clock circuit, a liquid crystal display (LCD) for displaying figures representative of date and time, and an LCD device serving as a pattern exposure mask for exposing a figure pattern of date and time to a film.

With this kind of data recording system, it is necessary to have an electrical circuit, or timer, which maintains one or more of time data, date data or name data. In general, a microprocessor is used in this electrical circuit, with a liquid crystal oscillator connected to the microprocessor to provide clock signals to the microprocessor. The microprocessor is able to record the correct time by adding these precise clock signals from the liquid crystal oscillator to stored time and date data. In addition, to record the copyright information, a selective memory means which allows the photographer's name to be recorded is also provided using the same microprocessor.

Pictures taken with an optical camera using standard optical emulsion based film such as Kodak film are usually taken through a shutter, shutter release, and lens system. The shutter acts to block light from reaching the film which is mounted behind the lens so that the image cannot be formed on the recording media until the user is ready. When the shutter release is activated, the shutter will open for a usually predetermined length of time, known as the shutter speed, and light will pass through an aperture and form the image on the recording media. The shutter speed and aperture are determined by the microprocessor or manually controlled and the microprocessor is able to record these values and other exposure related information and print them together with the time and date information. A shutter may also be included in a digital camera, although the CCD may be activated and record an image on demand, without worry of exposing the film of a film type camera. In a video recorder, the shutter may be eliminated but other pertinent recording information such as light values may be recorded.

However, information about the location of the photograph must be manually recorded by the photographer and later correlated with the photograph. Therefore, there is a need to automatically record the location of the photograph or video at the time it is taken.

### SUMMARY OF THE INVENTION

The present invention determines the location of the photograph or video when taken and records the information on the recording media. The location information, together with the time, date and exposure information can be recorded in the inside or outside of the image area.

According to the method of the present invention, an apparatus, system, and method is provided for automatically determining the whereabouts of a user through a Global Position Satellite (GPS) or through cellular telephone signals. The system determines the location coordinates and references either a table stored in local memory or remotely stored on the World Wide Web (WWW) through a wireless link.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates system elements according to an embodiment of the camera system of the present invention.

FIG. 2 illustrates system elements associated with another embodiment of the camera of the present invention.

FIG. 3 provides a flowchart illustrating a process for determining picture location on a frame by frame basis, according to an embodiment of the present invention.

### DETAILED DESCRIPTION OF THE INVENTION

The camera determines the location of the image at the time it was taken and records the location information either as latitude and longitude coordinates or any combination of the name of the city, state, province, county, country or area where the image was recorded, together with time, date, exposure data, the photographer's name, copyright data, and any other information the photographer may desire (the Information). The recording of the image can be on various media, such as emulsion type film common to film based cameras, magnetic tape common to video cameras, or integrated circuit memory common in current digital cameras. Therefore the system can work with a traditional optical camera, digital camera, or video camera.

Digital cameras are well known in the art and employ a variety of storage media such as integrated circuit memory or optical compact disk media. In a digital camera a CCD records the light rather than the silver salt emulsion based films such as those produced by Kodak or Fuji which are widely available to buy and process at any corner drugstore. A microprocessor controlled system records the image captured by the optical CCD and records it on the storage media. The integrated circuit memory may be of any type of ROM, EEPROM or EPROM, and is preferably a flash memory card such as that produced by a number of manufacturers including SanDisk, Toshiba, and Sony.

According to the invention, location can be determined with a Global Positioning System (GPS ) receiver or by usage of cellular telephone signals. GPS location determination is well known in the art and many U.S. Patent Numbers disclose such functionality and are hereby incorporated by reference: U.S. Pat. Nos. 6,014,090; 4,550,317; 4,598,372; 4,815,012; 4,888,698; 5,129,011; 5,315,298; 5,381,338; 5,422,814. Cellular determination can be calculated by the camera by triangulation, including usage of a control channel. The location can also be transmitted to the camera's receiver from a cellular provider.

The system for determining the image location or position may utilize any known method for determining the location of the camera. Some of the many methods are briefly described below. It should be understood that the present invention should not be limited to any particular embodiment or illustration of localizing the camera by usage of a control or location channel, or by triangulation.

Under the GSM, PACS, FDMA, CDMA, or TDMA technology, there are 8 logical channels per radio frequency channel which are available for communication of which 7 channels are used for voice/data transmission and 1 channel is used as a control channel. The control, channel is normally used by the GSM, PACS, FDMA, CDMA, or TDMA network to verify the caller's identification and billing information. In addition, the control channel is used for switching the caller between communication towers typically when the caller is close to becoming out of the range of a transmitting tower. As such, there are times when the control channel is not in use by the digital GSM, PACS, FDMA, CDMA, or TDMA communications network. U.S. Pat. No. 6,014,089 discloses transmission via the voice and control channel of a GSM, FDMA, CDMA, or TDMA network and usage of and is hereby incorporated by reference.

In known techniques for mobile telephone location, the distance between a mobile telephone and a mobile telephone system antenna in a cell site can be determined by analyzing the signal strength of a communication signal between the cell site antenna and the mobile telephone. If the distance between the mobile telephone and a number of cell site antennas is calculated, the approximate location of the mobile telephone can be determined by a geometric process such as triangulation. U.S. Pat. No. 5,732,354 describes such a system and is hereby incorporated by reference. The system measures the signal strengths of control and voice channels of nearby cells. These control and voice channel signal strength measurements are used to determine the location of the WD which is sent to the activity server.

For CDMA devices it is possible to use two types of physical sub-channels in order to determine the location of the wireless device, the Dedicated Physical Data Channel and the Dedicated Physical Control Channel as described in U.S. Pat. No. 6,009,091, which is hereby incorporated by reference. Other radio trilateration techniques have been widely used in wireless device location systems and details of such systems can be found in U.S. Pat. No. 6,009,091 dated Dec. 28, 1999 Stewart et al., and Telecommunications Industry Associate (TIA) contribution “Location Power Up Function,” TR 45.5.2.3/97.07.17.02 by A. Ghosh, G. Bruckert, B. Verbiscer and M. Panjwani and in ETSI SMG2 document UMTS A36/97 and U.S. Pat. No. 5,508,708 dated Apr. 16, 1996 by Ghosh et al.

It is also possible to locate the camera by utilizing the control channel or location channel in combination with a radio wave from a global positioning satellite (GPS) as described by U.S. Pat. No. 5,999,126 dated Dec. 7, 1999 to Ito, which is hereby incorporated by reference. In such a system the camera includes a first position measuring means for position-measuring a first position by receiving a radio wave from a GPS satellite, a second position measuring means for measuring a second position by receiving a radio wave from a base station of a cellar telephone system without transmitting any request signal for position-measuring to the base station, an evaluating means for evaluating uncertainty of in data derived from the first position measuring means and/or the second position measuring means, a selecting means for selecting data from the first position measuring means or the second position measuring means based on an output signal from the evaluating means, a data storage means for storing position data including a map, and optionally a display signal generating means for generating a display signal by combining an output signal from the selecting means and output data from the data storage means, and a display means for displaying the display signal.

It is to be understood that the embodiments shown and described herein are only illustrative of the principles of the present invention and that various modifications may be implemented by those skilled in the art without departing from the scope and spirit of the invention.

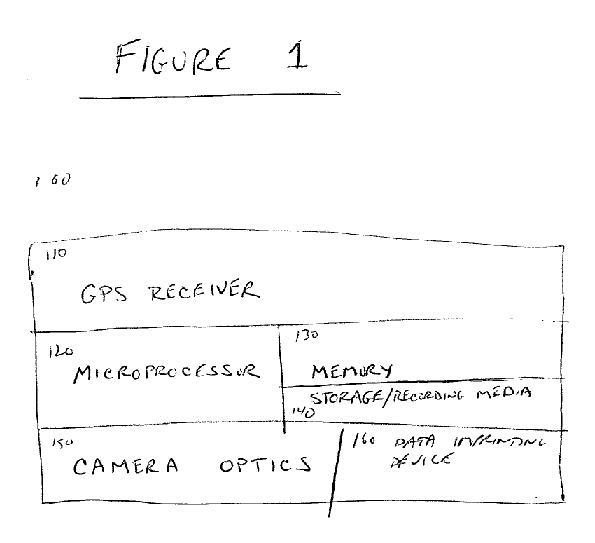

FIG. 1 illustrates system elements associated with the camera 100. GPS receiver 110 is connected to microprocessor 120. The microprocessor is used to control the GPS receiver according to instructions contained in memory 130. Memory 130 may comprise any type and combination of computer memory such as ROM, RAM, flash, magnetic and optical storage etc. The microprocessor is also used to control camera optics 150. The camera optics such as the lens, aperture, and shutter are controlled by the microprocessor together with a light meter to expose the storage/recording media 140 to the proper level. The storage/recording media 140 may be film, integrated circuit memory/storage, or magnetic media. Other storage media such as Recordable CD (CDR) are also envisioned.

Data imprinting device 160 can be an LCD system in the case that the storage media is film. Data imprinting is well known, and an LCD imprinting system is described in U.S. Pat. No. 5,903,785 which is hereby incorporated by reference, and illustrates how a date recordable camera incorporates a date recording device having a clock circuit, a liquid crystal display (LCD) for displaying figures representative of date and time, and an LCD device serving as a pattern exposure mask for exposing a figure pattern of date and time to a film.

Data imprinting device 160 can also be a computer program or instruction set located in memory 130 and executed by microprocessor 120 to record the Information to memory in the case of a digital camera where the storage/recording media 140 is a digital non film based media. In the case of a digital still camera or digital video camera, the Information is displayed in conjunction with the individual images or can be changed periodically with a continuous image. The Information can be located within the image area or positioned adjacent to the image. In the case of a magnetic media video recorder the information can likewise be located in or adjacent to the image area.

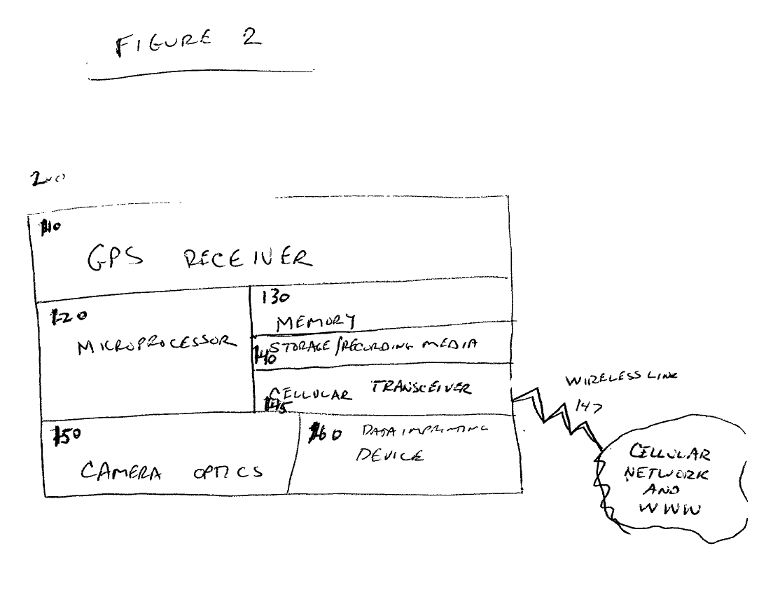

FIG. 2 illustrates the system components of camera 200. Camera 200 is comprised the same components of camera 100 but also contains cellular transceiver 145. Cellular transceiver 145 is used to communicate with a cellular network which intern can be used to access computers located on the Word Wide Web in order to associate GPS location information with a database of location names. The GPS 110 may determine the location alone, or in combination with the cellular transceiver 145 as described by U.S. Pat. No. 5,999,126 dated Dec. 7, 1999 to Ito, previously incorporated by reference. Alternatively, camera 200 may not incorporate the GPS receiver but utilizes the cellular transceiver 145 in order to determine or calculate the position information in a triangulation process as previously described.

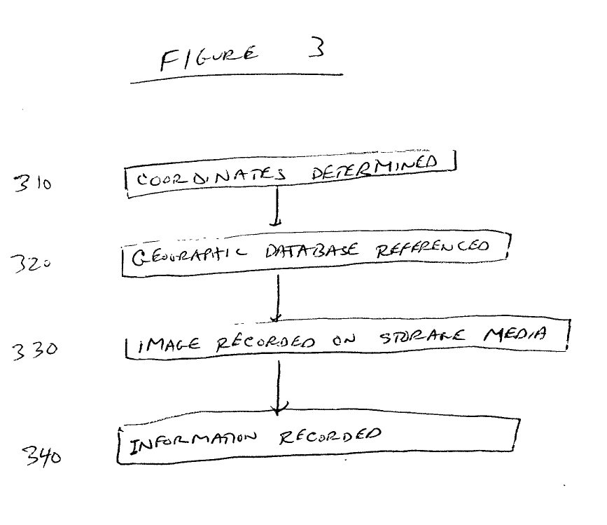

FIG. 3 illustrates one possible embodiment of the invention. In step 310 the location of the camera is determined. The location is determined utilizing either the GPS receiver 110 or cellular transceiver 145. The coordinates may be regularly updated, updated on demand when the shutter is activated, or updated according to the desire of the user. In order to record the image as quickly after the user presses the shutter or prompts the image to be recorded, the location determination may take place at the same time as the image recording or may be delayed until after image recordation is complete.

In step 320 a geographic database is referenced in order to determine the name of the location where the image is being recorded. The name can contain any combination of the address, city, state, county, region, zone, and country. The GPS coordinates may also be recorded in conjunction with the location name. The geographic database may be located in memory 130 to of camera 100 or may alternatively be located remotely on a computer on the WWW. If the geographic database is remotely located, cellular transceiver 145 operates over wireless link 147 to connect to the WWW. A computer on the WWW then transmits the location name to the camera. In an embodiment where camera 100 does not utilize the GPS receiver 110 to determine the location, the location name may be directly transmitted to the cellular connection over any channel by the local cellular provider. Alternatively, a program running with microprocessor 120 and memory 130 may be utilized to calculate the location name.

In step 330, an image is recorded on the storage media. The image may be either a still image or a continuous image.

In step 340, the Information, which includes any combination of the date, time, location, and exposure information is recorded on the storage media. Step 330 may occur at the same instant as step 340, or slightly before or after step 330. In any type of camera, the Information is correlated with the image. In the case of a film based camera, the information is imprinted near or in the image frame, preferably under the frame. In the case of a digital camera, the Information is correlated by a tag associating the information with the image. The information may be displayed in the image frame, or may not be displayed at all, but only stored and accessed later by the camera or by a program running on a PC linked to the camera. Likewise, with a video camera, the Information may be displayed in or near the frame, or may be saved in memory in the case of a digital camera and entered into frame during subsequent editing of the video.

In a digital still or video camera, the location information may first be stored in memory and later manipulated after the images have been recorded, either by the camera itself or by a computer connected to the camera when the images are uploaded to a personal computer. A journey itinerary or travelog including images taken by the user, locations and map routes can be created using the system of the present invention.

While the invention has been described in detail and with reference to specific embodiments thereof, it will be apparent to one skilled in the art that various changes and modifications can be made therein without departing from the spirit or scope thereof. Thus, it is intended that the present invention covers the modifications and variations of this invention.

All patents referred to in this application, whether in the background or detailed description are incorporated by reference in their entirety.

1. A camera comprising:
optics;
an image storage medium; and
a microprocessor that determines and records the location where an image or a series of images is taken on or in the storage medium.

2. The camera of claim 1, wherein the storage medium is an emulsion type film, and wherein the location is imprinted on the film.

3. The camera of claim 2, wherein the microprocessor further records information regarding the exposure of the photo and date of the photo on or in the storage medium.

4. The camera of claim 2, wherein the location is imprinted in the image.

5. The camera of claim 2, wherein the location is imprinted outside of the image.

6. The camera of claim 3, wherein the exposure information comprises, the aperture setting, the shutter speed, the film speed.

7. The camera of claim 6, wherein the exposure information further comprises metering information such as aperture priority, shutter priority, or under or over exposure settings of +/−f stops.

8. The camera of claim 1, wherein the image is stored in the storage medium in a digital format.

9. The camera of claim 8, wherein the storage medium is solid state memory.

10. The camera of claim 8, wherein the storage medium is an optical disk.

11. The camera of claim 9, wherein the solid state memory is contained in a removable memory card.

12. The camera of claim 8, wherein the storage medium is flash type memory.

13. The camera of claim 1, wherein the location is determined for each image recorded.

14. The camera of claim 1, wherein the location is determined for a series of images.

15. The camera of claim 1, wherein the location information comprises geographic coordinates.

16. The camera of claim 1, wherein the location information comprises the name of the city, state, country, province, or locale where the image was taken.

17. The camera of claim 1, wherein microprocessor controlled system comprises a global positioning system.

18. The camera of claim 1, wherein the microprocessor controlled system comprises a cellular transceiver.

19. A method for determining and recording the location of an image comprising:
capturing and recording the image on a storage medium with a camera;
determining the location where the image was captured with said camera; and
recording the location where the image was captured on the storage medium, such that the image and the location are correlated.

20. The method of claim 19, further comprising manipulating the images and locations into a travel log.

21. The method of claim 19, wherein the storage medium is flash memory.

22. The method of claim 19, wherein the storage medium is an emulsion type film.

23. The method of claim 19 wherein determining the location comprises communicating with global positioning satellites via a global positioning receiver.

24. The method of claim 19 wherein determining the location comprises triangulating the location of the camera via a cellular transceiver.

25. The method of claim 23 wherein determining the location comprises triangulating the location of the camera via a cellular transceiver.

26. The method of claim 23 wherein the location is determined for each image recorded by the camera.

27. The method of claim 23 wherein the location is determined when prompted by a user of the camera.

28. The method of claim 27, wherein the prompting is triggered by taking of the image or by a separate command issued by the user.

29. The method of claim 23, wherein triangulating the location of the camera comprises usage of a cellular control channel.

30. The method of claim 19, wherein the image location is recorded in or near the image frame.

31. The method of claim 19 further comprising recording exposure information for each image recorded.

32. The method of claim 19 wherein determining the location comprises determining the geographic coordinates of the location.

33. The method of claim 32 further comprising correlating the geographic coordinates with the name of the location.

34. A camera for capturing an image comprising:
optical lens means for capturing an optical image;
means for recording the optical image onto a storage medium;
means for determining the location where the optical image was captured; and
means for recording the location onto the storage medium.

35. The camera of claim 34 wherein the means for recording the optical image records a digital image, and wherein the storage medium is a flash memory card.

36. The camera of claim 34 wherein the means for determining the location comprises a GPS receiver that determines the position of the camera when the image is captured.

37. The camera of claim 34 wherein the means for the determining the location comprises a cellular transceiver that triangulates the position of the camera when the image is captured.

38. The camera of claim 34 wherein the means for recording the location comprises and optical mechanism that exposes a portion of the storage medium with light in order to record the information on the storage medium.

39. The camera of claim 34, wherein the means for determining the location determines the name of the location of the image.

40. The camera of claim 34, wherein the means for determining the location determines the geographic coordinates of the location of the image.

41. A camera comprising:
an optical lens for focusing an image onto a focal plane;
a storage medium for recording the image, the medium comprising film or memory cells;
a location sensing system, the system configured to record the location onto the storage medium.

42. The camera of claim 41, wherein the location sensing system comprises a cellular transceiver, the system configured to triangulate the position of the camera through signals sent and/or received by the transceiver.

43. The camera of claim 42, wherein one or more of the signals is sent and/or received over a cellular control channel.

44. The camera of claim 41, wherein the location sensing system comprises a GPS receiver.

45. The camera of claim 41, wherein the camera is a video camera.

46. The camera of claim 1, wherein the camera is a video camera.
